(19) United States
(12) Patent Application Publication
(10) Pub. No.: US 2020/0061799 A1
(43) Pub. Date: Feb. 27, 2020

(54) FINGER MOUNT SYSTEM

(71) Applicant: Bernard Fryshman, Brooklyn, NY (US)

(72) Inventor: Bernard Fryshman, Brooklyn, NY (US)

(21) Appl. No.: 16/109,040

(22) Filed: Aug. 22, 2018

(51) Int. Cl. B25G 1/10; A46B 5/04

(52) U.S. Cl. CPC B25G 1/107; A46B 5/04

(57) ABSTRACT

A finger mount system includes a finger mount configured to receive at least a portion of a finger. The finger mount system also includes a tool mount connected to the finger mount and configured to receive a tool. The finger mount system further includes the tool, wherein movement of the finger mount by the finger results in movement of the tool.

### BACKGROUND

Changing societal norms have resulted in large numbers of people living alone. Correspondingly, food is purchased in smaller quantities and, in some cases, cooking pots, pans, and baking dishes are smaller as well. Food preparation, however, still involves the use of a large variety of different utensils and tools, such as knives, peelers, choppers, scrapers, openers, etc., many of which are unnecessarily large, inconvenient, and may require special food preparation skills associated with larger scale cooking. Additionally, it can be problematic to store such a large number of bulky utensils, especially in a smaller kitchen setting. A variety of other household responsibilities also involve the use of tools and implements which are unnecessarily large, and which often call for skilled usage.

### SUMMARY

Described herein is an approach to using tools, utensils, and other implements which are guided and controlled by one's finger. The systems described herein enable functions to be carried out without the need for a separate tool that is held in one's hand. In one embodiment, an illustrative finger mount system includes a finger mount configured to receive at least a portion of a finger. The finger mount system also includes a tool mount connected to the finger mount and configured to receive a tool. The finger mount system further includes the tool, wherein movement of the finger mount by the finger results in movement of the tool.

Other principal features and advantages of the invention will become apparent to those skilled in the art upon review of the following drawings, the detailed description, and the appended claims.

### BRIEF DESCRIPTION OF THE DRAWINGS

Illustrative embodiments will hereafter be described with reference to the accompanying drawings, wherein like numerals denote like elements. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a block diagram depicting components of a finger mount system in accordance with an illustrative embodiment.

FIG. 2 depicts a finger mount system in accordance with an illustrative embodiment.

FIG. 3 depicts a computing system included in an electronics unit of a finger mount system in accordance with an illustrative embodiment.

### DETAILED DESCRIPTION

Embodiments of the present subject matter will now be described with reference to the above-identified figures. However, the drawings and the description herein are not intended to limit the scope of the invention. It will be understood that various modifications of the present description are possible without departing from the spirit of the invention. Also, features or operations described herein may be omitted, additional operations or features may be included, and/or features or operations described herein may be combined in a manner different from the specific combinations recited herein without departing from the spirit of the invention.

Described herein is a finger mount system that has a variety of different applications, including food preparation and consumption, woodworking, cosmetics, crafting, personal hygiene, construction, etc. The finger mount system includes a finger mount portion that securely attaches the system to a user's finger. In an illustrative embodiment, the finger mount system can be used with an index finger. Alternatively, the finger mount system may be used with any of the user's fingers, including a pinkie, a ring finger, a thumb, a middle finger, or an index finger. The finger mount system also includes a tool mount portion that is connected to the finger mount portion and configured to securely receive and mount a tool. Depending on the implementation, the finger mount system can also include other components such as a battery, an electronics unit, an actuator, a light, a camera, etc. As discussed herein, the proposed systems enable functions to be carried out without the need for a separate tool that is held in one's hand.

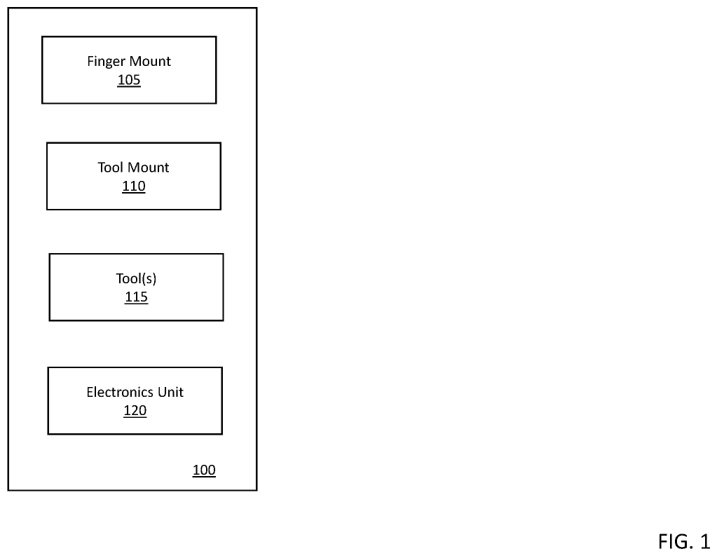

FIG. 1 is a block diagram depicting components of a finger mount system 100 in accordance with an illustrative embodiment. The finger mount system 100 includes a finger mount 105, a tool mount 110, one or more tools 115, and an electronics unit 120. In alternative embodiments, the finger mount system 100 may include fewer, additional, and/or different components. The finger mount 105 is used to mount the finger mount system (or system) 100 to at least a portion of a finger of a user. In one embodiment, the finger mount 105 is a cylindrical receptacle that form fits to the user's finger. A friction fit can be used to prevent the finger mount 105 from falling off of the finger while the system is in use. In such an implementation, the finger mount 105 may be sized specifically for a user's finger, similar to the sizing and fitting process for a ring.

In an alternative embodiment, the finger mount 105 can include one or more straps to secure the finger mount 105 to a finger. For example, one or more Velcro® straps can be attached to a cylindrical portion of the finger mount 105 and used to secure the cylindrical portion to a finger of the user. As another example, one or more straps, cords, strings, etc. can be secured to the cylindrical portion of the finger mount 105 and used to secure the cylindrical portion to a wrist strap that is connected to the one or more straps, cords, or strings. The finger mount 105 can also include a glove or other hand covering that is connected to the cylindrical portion and used to secure the cylindrical portion to the end of the user's finger.

In another embodiment, an interior of the finger mount 105 can include an encased malleable material that a user is able to form around the end of his/her finger to obtain a form fit for the finger mount 105. The malleable material can be a clay, putty, gel, or other formable material. In another embodiment, an interior of the finger mount 105 includes a sleeve that is made from a stretch material and configured to securely receive a finger. The stretch material can be an elastic, Spandex, or other material that expands to the size of the user's finger and provides a one size fits all product. In yet another embodiment, an interior of the finger mount 105 includes a biocompatible adhesive that adheres the finger mount to the user's finger.

In an illustrative embodiment, the finger mount 105 is configured to receive a single finger of a user. In an alternative embodiment, the finger mount 105 can be configured to receive multiple fingers of the user such that the user has more control and strength when using the finger mount system 100.

The system 100 also includes a tool mount 110 which is used to secure a tool to the finger mount system 100. In one embodiment, an end of the tool mount 100 includes an opening that is configured to receive a mounting end of a tool and secure the mounting end of the tool via a friction fit. In an alternative embodiment, the tool mount 110 includes a solid end that is received by an opening in the mounting end of the tool, similar to a socket wrench connection to a socket.

In one embodiment, the tool mount 110 can include a depressible ball on its exterior surface that is configured to mate with a dimple formed in an interior of an opening in the mounting end of the tool. The depressible ball can be activated (i.e., depressed) via the insertion/removal forces used to insert/remove the tool from the tool mount 110. In such an embodiment, the depressible ball increases the amount of force needed to mount or remove the tool from the tool mount 110, making the tool more secure on the tool mount 110. Alternatively, the depressible ball can be depressed by pressing a button on the finger mount system 100. Pressing the button causes the depressible ball to retract, allowing for easy insertion of the tool onto the tool mount 110 and easy removal of the tool therefrom. Additionally, releasing the button allows a portion of the depressible ball to extend outward from an external surface of the tool mount 110 and mate with an indentation (or dimple) in the interior surface of the tool. This allows the tool to remain securely mounted to the tool mount 110 until the user depresses the button to remove the tool by disengaging the depressible ball from the indentation. In an alternative implementation, the depressible ball can be on the tool and the indentation can be on the tool mount 110.

The tool mount 110 can include a threaded opening that is configured to receive a fastener such as a screw or bolt. The fastener can be placed through a surface of the tool mount 110 such that an end of the fastener contacts the tool being mounted. As a result, the tool is securely mounted to the tool mount 110 until the fastener is loosened to release the tool. In an alternative implementation in which a mounting portion of the tool fits over the tool mount 110, the fastener can be inserted through a threaded opening in the surface of the tool such that the fastener contacts the tool mount 110 to securely hold the tool thereon. In either implementation, a terminal end of the fastener can rest in an indentation in the inner receiving component (i.e., either the tool mount 110 or the mounting portion of the tool). The indentation can be a threaded opening that aligns with the through hole in the outer component. Alternatively, the indentation may not be threaded.

In another illustrative embodiment, the tool mount 110 is a single tool mount configured to hold a single tool. Alternatively, the finger mount system can include a plurality of tool mounts configured to hold a corresponding plurality of tools. In another alternative embodiment, the finger mount system 100 can include a single tool mount that is configured to support a plurality of tools. In another illustrative embodiment, the tool mount 110 is configured to receive different interchangeable tools depending on the user's needs, and each of the tools is configured to mate with the tool mount 110. In an alternative implementation, one or more tools can be permanently mounted to the tool mount such that the system is a dedicated system that does not utilize interchangeable tools.

In an illustrative embodiment, the tool mount 110 is integrally formed with the finger mount 105 to form a portion of the system 100. In an alternative embodiment, the tool mount 110 can be mounted to the finger mount 105 via an adhesive, stitching, soldering, welding, etc. The finger mount 105 and the tool mount 110 can be made from any of a variety of materials, including any combination of plastic, metal, and cloth.

The tool(s) 115 can include any of a variety of components that can be interchangeably mounted to the tool mount 110. The tools 115 can include food preparation and cooking utensils such as a knife, spatula, grater, scraper, whisk, etc. The tools 115 can also include eating utensils such as a steak knife, butter knife, fork, spoon, spork, etc. The tools 115 can also include carpentry implements such as a file, saw, utility knife, sandpaper holder, paint brush, wire brush, screwdriver, wrench, etc. The tools 115 can also include cosmetic applicators such as a makeup brush, eyeliner brush, lipstick holder, fingernail or toenail polish applicator, blush applicator, etc. The tools 115 can further include personal hygiene tools such as a nail file, hairbrush, comb, toothbrush, etc.

Each of the tools includes a tool mounting portion which is configured to mate with the tool mount 110 such that the tool 115 is securely mounted to the system. The tool mounting portion is configured to mate with the tool mount 110, and can be a male end or a female end that mates with the tool mount to form a friction fit. Alternatively, as discussed above, a socket configuration can be used, a depressible ball and indentation configuration can be used, a fastener can be used, etc. to secure the tool 115 to the tool mount 110. The tools are interchangeable in one embodiment, such that the user is able to obtain a number of different tools to perform a variety of different tasks. For example, as discussed, the user can use the system 100 for eating, food preparation, carpentry, personal hygiene, makeup application, artwork, writing, dispensing, etc.

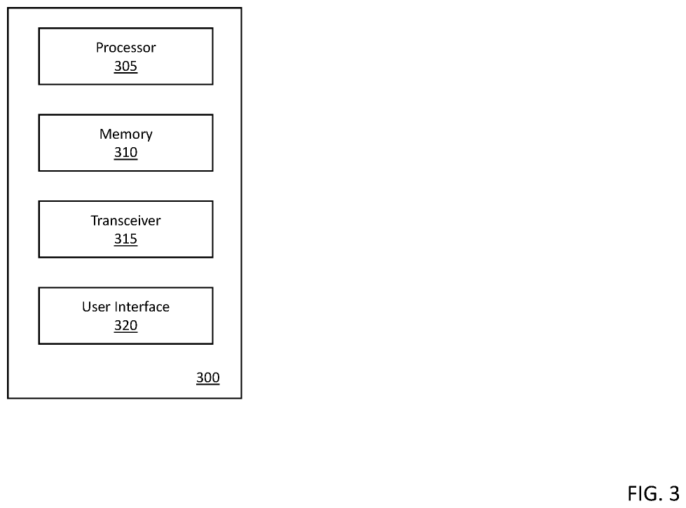

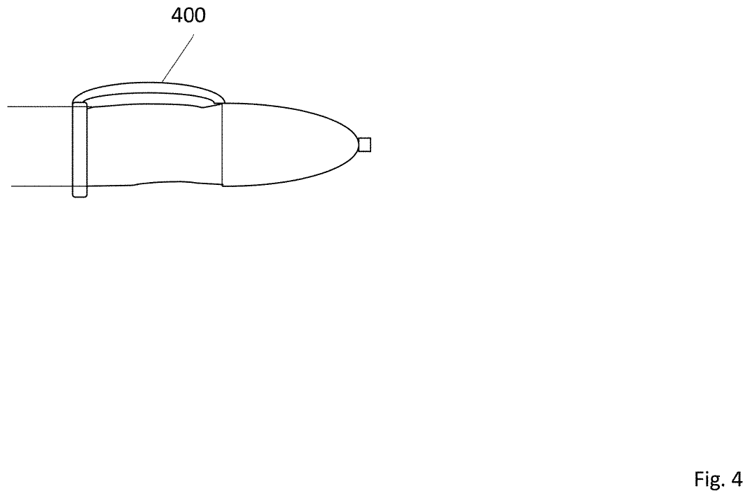

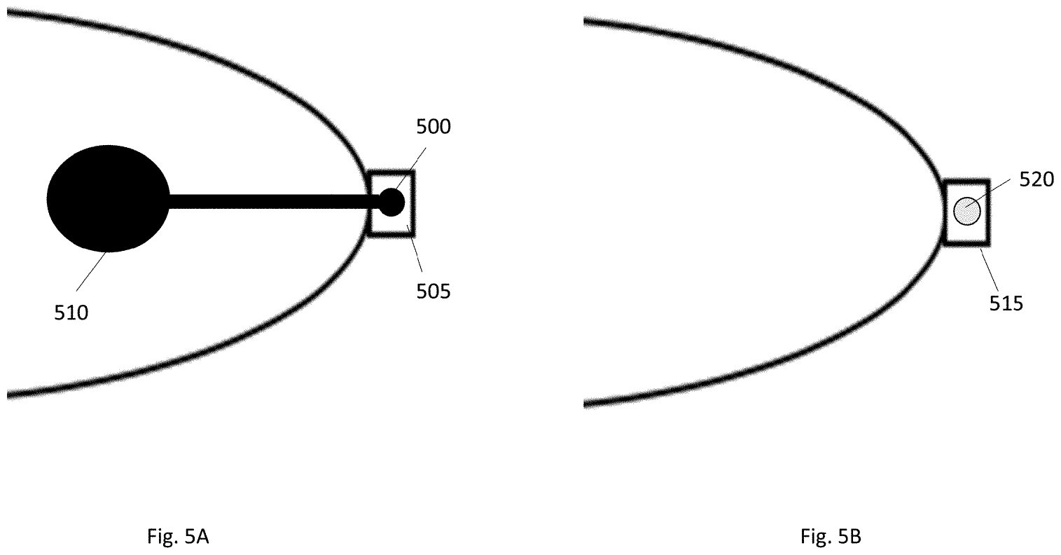

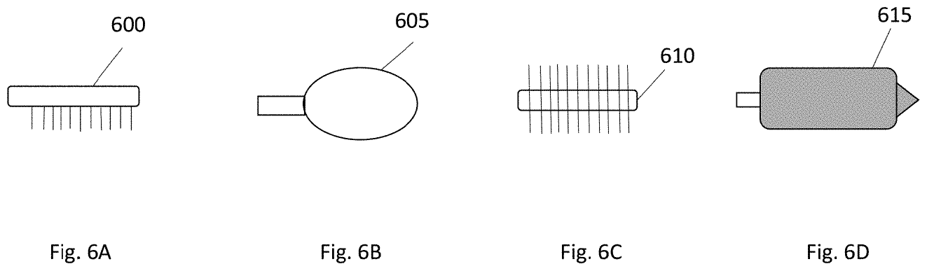

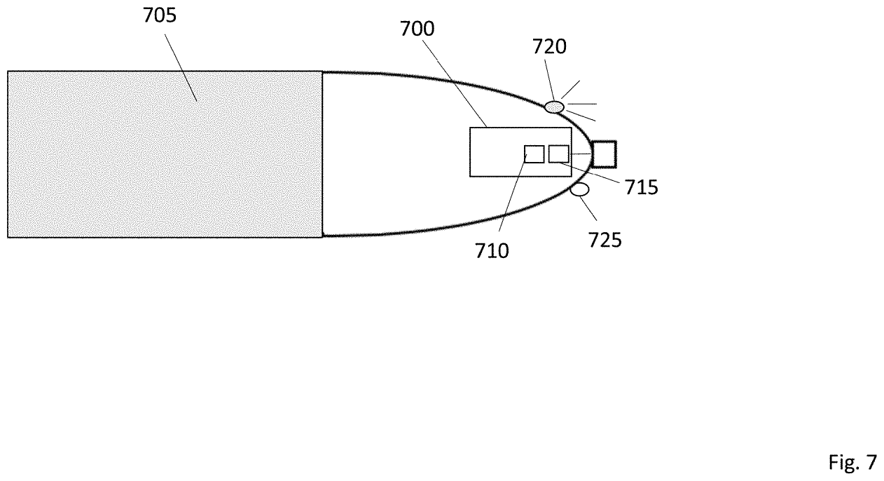

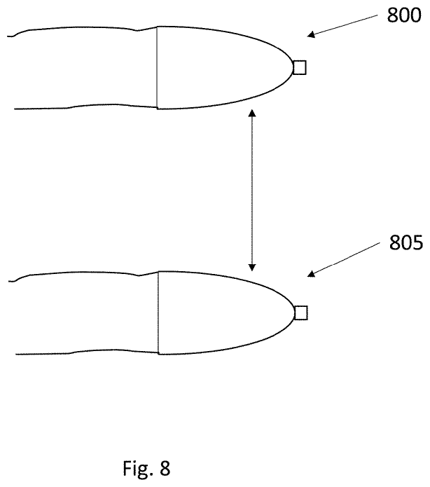

The electronics unit 120 can include a number of different components, depending on the implementation of the system 100. For example, the electronics unit 120 can include a computing device that has a processor, memory, transceiver, and interface. Such a computing device is described in more detail with reference to FIG. 3. The electronics unit 120 can also include a battery and an actuator in one embodiment. The actuator can be used to power the tool 115 via the tool mount 110, and the battery is used to provide power to the actuator. The actuator can be an electric motor or other component that moves, rotates, and/or vibrates the tool mount 110 and the tool 115 mounted thereto. For example, the actuator can be used to vibrate a toothbrush tool that is mounted to the tool mount 110.

The electronics unit 120 can also include a camera or other image capturing device. The camera can be used to capture images and/or video of a work surface and/or item which is being worked on by a user of the system 100. In one embodiment, the camera is in electrical communication with a computing system housed in the electronics unit 120. The computing system includes a transceiver that is used to transmit the captured images/video to a user device such as a tablet, smart phone, laptop computer, etc. As such, the user has an enlarged view of the work surface and item being worked upon, which can be very helpful for individuals with poor vision and/or in situations in which the item being worked upon is small.

The electronics unit 120 can also include a light, such as light-emitting diode (LED) light source. The light can be used to illuminate a work surface such that the user has better visibility in dark conditions or when precision work is involved. The light can also be a laser pointer or similar light that can be used by a teacher or presenter to highlight remote items. The light can also be used to interact with an electronic screen, such as a computer screen. In such an embodiment, the system can take the place of a traditional computer mouse, by enabling the user to interact with the screen through the finger mount system 100.

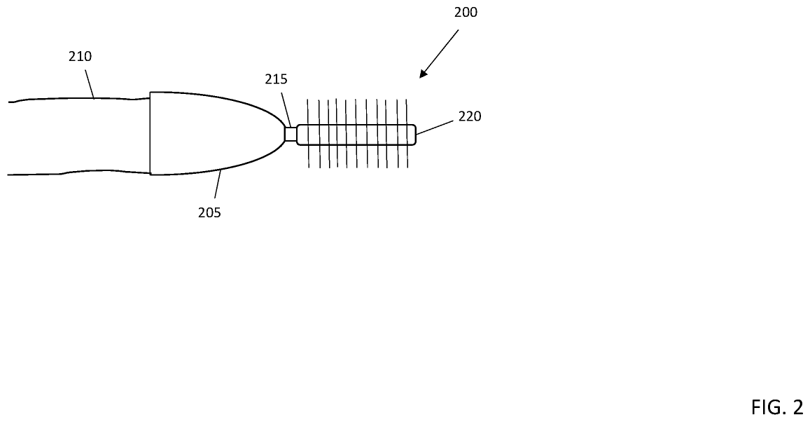

FIG. 2 depicts a finger mount system 200 in accordance with an illustrative embodiment. The finger mount system 200 includes a finger mount 205 which is mounted to a finger 210 of a user. As discussed herein, the finger mount 205 can be secured to the finger 210 via an adhesive, via a fitted sleeve, via a malleable material that is formed to the finger 210, via one or more straps, via Velcro®, etc. The finger mount system 200 also includes a tool mount 215 attached to the finger mount 205. The tool mount 215 can be stationary or movable depending on the implementation. For example, the tool mount 215 may rotate either through manual force applied by the user or via a battery powered actuator that is included in an electronics unit of the system. The electronics unit can be incorporated into the finger mount 205, the tool mount 215, or the tool itself, depending on the configuration. The system 200 of FIG. 2 also includes a brush 220 as an example tool. The brush 220 can be a toothbrush, a paintbrush, a makeup brush, a wire brush, etc. In alternative embodiments, a different tool (or tools) may be mounted to the system 200.

In an illustrative embodiment, any of the tool operations described herein may be controlled by a computing system that includes a memory, processor, user interface, transceiver, and any other computing components. The tool operations can be stored as computer-readable instructions on a computer-readable medium such as the computer memory. Upon execution by the processor, the computer-readable instructions are executed as described herein.

FIG. 3 depicts a computing system 300 included in an electronics unit of the system in accordance with an illustrative embodiment. The computing system 300 includes a processor 305, a memory 310, a transceiver 315, and a user interface 320. In alternative embodiments, the computing system 300 may include fewer, additional, and/or different components. The components of the computing system communicate with one another via one or more buses or any other interconnect system. The computing system 300 can be incorporated into any portion of the proposed system, including the finger mount, the tool mount, and/or the tool itself.

The processor 305 can be any type of computer processor known in the art, and can include a plurality of processors and/or a plurality of processing cores. The processor 305 can include a controller, a microcontroller, a hardware accelerator, a digital signal processor, etc. Additionally, the processor 305 may be implemented as a complex instruction set computer processor, a reduced instruction set computer processor, an x86 instruction set computer processor, etc. The processor is used to run an operating system, which can be any type of operating system and can be stored in the memory 310.

The processor 305 also uses instructions or algorithms stored in the memory 310 to control an actuator of the system, depending on the type of tool that is connected to the system. For example, the processor 305 can control an actuator to rotate the tool if the tool is a screwdriver, drill bit, or other rotating tool. The processor 305 can control an actuator to vibrate the tool if the tool is a toothbrush or other vibratory tool. In one embodiment, the processor 305 can use the transceiver 315 to communicate with the tool and determine the tool type. For example, the transceiver 315 can direct a radio frequency identifier (RFID) signal to the tool, which can respond with information including the tool type. Alternatively, a different communication algorithm may be used. Based on the tool type, the processor 305 can access the appropriate instructions for controlling the tool based on user commands or actions. The processor 305 is also used to control other components of the system such as a video camera, a light, etc.

The memory 310 is also used to store programs, user data, network and communications data, tool information, etc. The memory 310 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc.

The transceiver 315 includes transceiver circuitry that allow the computing system to transmit and receive data to/from other devices such as remote computing systems, servers, websites, tools, etc. The transceiver 315 enables communication through a network, which can be one or more communication networks. The network can include a cable network, a fiber network, a cellular network, a wi-fi network, a landline telephone network, a microwave network, a satellite network, etc. The transceiver 315 also includes circuitry to allow device-to-device communication such as Bluetooth® communication. In one embodiment, the transceiver 315 can be used to link two or more finger mount systems for coordinated activity between the systems. For example, a user may mount a first finger mount system on his/her left index finger and a second finger mount system on his/her right index finger. The transceiver 315 can enable the two finger mount systems to communicate with one another for coordinated action of their actuators.

The user interface 320 is the framework which enables users and peripheral devices to interact with the computing system 300. The user interface 320 can include a small display, a speaker to provide audio indications, a microphone to receive voice instructions from the user, and/or any other user interfaces that allow the user to interact with and control the computing system 300.

As an example of using the proposed system, an individual may wish to scrape encrusted food from a kitchen surface. The individual could try to use his/her fingernail (typically on the index finger) to accomplish the task. However, such use of the fingernail is unsanitary, often ineffective, and sometimes damaging to the fingernail. Other techniques such as using a standard knife, single edge razor, screwdriver, abrasive cloth/powder, etc. have a high risk of damaging the kitchen surface, are inefficient, and also are time consuming. The systems described herein can be used to quickly and efficiently remove the encrusted food from the kitchen surface. Specifically, the individual can mount the finger mount of the system to his/her finger, and mount a serrated knife blade to the tool mount of the system. The serrated knife blade can be mounted such that the blade is perpendicular to the forward motion of the finger over the kitchen surface. The individual can then use the precision control afforded by the system to remove the encrusted food with the serrated knife blade without damaging the kitchen surface.

The same configuration from the above example (i.e., a serrated knife blade tool mounted to the tool mount of the system) can be used for cutting food or other material by rotating the tool mount 90 degrees such that the blade edge is perpendicular to the work surface. The system can also accommodate different types of blades for different types of cutting, such as chopping, piercing, etc.

As another example, the tool mounted to the tool mount can be a writing utensil such as a pen or pencil. Such an implementation can be particularly useful to individuals who are unable to hold a traditional writing utensil due to arthritis, lost fingers, or other hand ailments.

As another example, an individual may wish to tighten or loosen a fastener such as a screw or bolt. A loose screw is often tightened by hand, resulting in sore fingers and an inadequate tightening job. Other techniques such as using a credit card, identification card, coin, etc. are also often inadequate to get the job done. With the proposed system, the individual can simply mount a screwdriver tool (e.g., regular, star-shaped, square, phillips, etc.) to the tool mount and use his/her finger to tighten the screw with the tool. In embodiments with an actuator, the actuator can be used to rotate the tool mount and the tool to assist the individual with loosening and tightening of the screw. Similarly, different tools such as wrenches or sockets can be used to tighten and loosen bolts.

As another example, the tool can be a dispensing container that is configured to mount to the tool mount. In such an embodiment, the user can control dispensing from the container via an actuator that is controllable from within the finger mount. Specifically, the user can use his/her finger to apply pressure to the interior of the finger mount to press a button that controls dispensing from the container via the actuator. In an alternative implementation, the dispensing can be controlled via a button or other component located on an exterior surface of the finger mount, the tool mount, or the tool. Such a configuration can be used to enable the precise release of a substance such as cake decoration, oil, paint, water, etc. for a variety of applications. For example, the dispensing container can be used to place oil into small spaces of a rusted device that is being restored, an artist can dispense paint for detailed painting or sign work, a cake decorator can achieve intricate designs by dispensing frosting from the container, a user can precisely direct a pesticide at an insect, a user can apply foam for filling a crack, a user can apply glue from the dispenser, and so on. In such embodiments, the focus is on precise placement, which is intuitive if controlled by the finger, which provides better precision and control than an implement which is held in the user's hand.

The same intuitive, precision control provided by the proposed system is also evident in applications such as smoothing putty or plaster on a wall. Using a putty knife involves skill, whereas using a finger is more intuitive and does not involve practice or a developed skill. Mounting a putty knife tool to the tool mount will enable even an inexperienced person to properly smooth a surface.

The tools that can be mounted to the device can also be used to lift objects, pierce objects, sand objects, polish objects, to apply a dab of glue or other substance, to dissect animals or perform other precision cutting, etc. In an embodiment in which force is to be used, the system can be configured with two finger mounts configured to receive two fingers and two tools. The two tools can be used together to form tweezers, tongs, pliers, scissors, etc. for gripping, cutting, or applying force to an object. In such an implementation, the system can be configured for placement on adjacent figures (e.g., an index finger and thumb or middle finger of the same hand) or non-adjacent fingers. In another implementation, the user can use two independent systems on different fingers or hands to perform tasks such as applying force, etc.

As discussed above, the proposed system can also be used for carpentry, electrical work, plumbing, and general construction. The use of a finger mount attached to an interchangeable tool or container is particularly useful in construction activities because it reduces the size and number of tools and containers that have to be carried. Additionally, conventional tools are often carried in inconvenient and dangerous situations, such as climbing a ladder, etc. The proposed system is much easier to carry than a plurality of traditional handheld implements.

It should be understood that the disclosed embodiments have been described to provide the best illustration of the principles of the subject matter and its practical application to thereby enable one of ordinary skill in the art to utilize the system in various embodiments and with various modifications as are suited to the particular use contemplated.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A finger mount system comprising:
a finger mount configured to receive at least a portion of a finger;
a tool mount connected to the finger mount and configured to receive a tool;
the tool, wherein movement of the finger mount by the finger results in movement of the tool; and
a computing system that includes a processor, a memory, and a transceiver;
wherein the transceiver is configured to receive information from the tool; and
wherein the processor is configured to identify a type of the tool based on the received information, and wherein the processor is configured to access operating instructions based on the type of the tool, wherein the operating instructions are stored in the memory.

2. The system of claim 1, wherein the finger mount includes a sleeve configured to receive at least the portion of the finger.

3. The system of claim 1, wherein the finger mount includes one or more straps to secure the finger mount to the finger.

4. The system of claim 1, wherein at least one of the tool mount or the tool includes a depressible ball configured to secure the tool to the tool mount.

5. The system of claim 4, wherein at least one of the tool mount or the tool includes an indentation configured to receive the depressible ball.

6. The system of claim 5, further comprising a button that is configured to retract the depressible ball into the tool or the tool mount on which the depressible ball is mounted.

7. The system of claim 1, further comprising an electronics unit incorporated into at least one of the finger mount, the tool mount, or the tool.

8. The system of claim 7, wherein the electronics unit includes a light to illuminate an area adjacent to the tool.

9. The system of claim 7, wherein the electronics unit includes a camera that is configured to capture images or video of an area adjacent to the tool.

10. The system of claim 9, wherein the electronics unit further includes a transceiver configured to transmit the images or video to a computing device that is configured to display the images or video.

11. The system of claim 7, wherein the electronics unit includes an actuator that is configured to move the tool mount and the tool.

12. The system of claim 11, wherein the electronics unit further includes a battery configured to power the actuator.

13. The system of claim 11, wherein the actuator is configured to vibrate the tool.

14. The system of claim 11, wherein the actuator is configured to rotate the tool.

15. (canceled)

16. The system of claim 1, wherein the transceiver is configured to communicate with a second finger mount system to coordinate actions between the finger mount system and the second finger mount system.

17. (canceled)

18. (canceled)

19. The system of claim 1, wherein the tool comprises a cooking utensil, an eating utensil, a carpentry tool, or a personal hygiene tool.

20. The system of claim 1, wherein the tool comprises a dispenser container that is configured to dispense a substance.
